(19) United States
(12) Patent Application Publication
(10) Pub. No.: US 2004/0187149 A1
(43) Pub. Date: Sep. 23, 2004

(54) Method and apparatus for channel guide assisted remote control of content receivers

(76) Inventor: Joseph F. Halgas JR., Huntington Valley, PA (US)

Correspondence Address: Jack I. J'Maev, 11800 CENTRAL AVE., SUITE 110, CHINO, CA, 91710, US

(21) Appl. No.: 10/394,892

(22) Filed: Mar. 21, 2003

(51) Int. Cl. H04N 5/445; H04N 5/50; H04N 5/44; G06F 13/00; G06F 3/00

(52) U.S. Cl. 725/38; 725/39; 725/56; 348/734; 348/731

(57) ABSTRACT

Remotely controlling content receiver wherein a channel guide is displayed to a user. A channel selection control is activated when a channel selection activator is actuated by the user. The channel selection control comprises an overlay window that can be repositioned on a presentation screen. The channel guide is preserved under the overlay window when the overlay window is repositioned by the user.

### FIELD OF THE INVENTION

The present invention pertains to the remote control of content receivers; specifically, to a method and apparatus for remotely controlling a content receiver by facilitating channel selection through the use of a channel guide.

### BACKGROUND OF THE INVENTION

Not long ago, television and the Internet were separate entities. Television provided content that could be enjoyed on TV sets, while computers were used to access the Internet. With the evolution of both television and computer technology, TV and the Internet are beginning to converge. In fact, there are devices available today that allow a consumer to simultaneously watch TV and browse the Internet. These technologies have converged so much so, that watching TV and accessing the Internet are becoming joint, rather than separate activities. For example, many television programs now invite a viewer to visit a related Internet web site. One good example of this practice is used by television news casts. When a news story is presented on television, the television program encourages the viewer to visit a web site to learn more facts about that particular news story.

Of course, if a user is to access two different media, it is desirable to be able to use two display devices or to have a convenient means for displaying information from two content sources on a single display device. One method for providing a user with two displays is to provide a small, hand-held device that can be used to access the Internet while the user simultaneously views television content on a TV set. One typical hand-held device comprises, for example, an Internet browser that a user can use to view an Internet site. Many of these hand-held devices are endowed with wireless connectivity to the Internet so that a user can move freely about a room. This is really useful when Internet access and television viewing are concurrently enjoyed by a user because the user can shift positions as personal comfort dictates. Yet another example hand-held device further comprises a built-in remote control function that can be used to remotely control a TV set, for example, to select a television channel or control audio volume. Hence, a wireless, hand-held Internet “appliance” enables a user to watch television programming and use the hand-held device as both a remote control for the TV set and as an Internet portal.

Some of the usual problems with watching television continue to persist. One real problem is that of determining what content is available on the various television channels available to the user. Here is one way where the convergence of television and computer technology solves a real problem. Using a hand-held Internet appliance, a user can retrieve a web site that comprises a television program guide. By viewing this type of program guide web site, the user can obtain TV program information so as to determine what television programming is available.

In those cases where the user wants to change TV channels by using the hand-held device as a remote control, the present art requires the user to switch from an Internet browsing mode to a remote control function. When the user selects the remote control function incorporated into the hand-held device, the user can no longer see the channel guide information presented by the Internet browser. This requires the user to remember the channel number associated with a particular program when switching to the remote control function incorporated into the hand-held device. Then, the user can command the television set to the selected channel number using the remote control function.

### SUMMARY OF THE INVENTION

One drawback with the prior art is the fact that a channel selection guide presented by a Web browser cannot be displayed when a hand-held device is used in the remote control mode. The present invention comprises a method for remotely controlling a content receiver wherein the presentation of the channel guide can be continued even when a user also calls upon a remote control function integrated into a hand-held device.

According to one illustrative method of the present invention, a content receiver is controlled by receiving a channel guide, presenting a channel selection tool to a user, receiving a channel selection from the channel selection tool and then conveying the channel selection to the content receiver. According to one variation of the present method, the channel guide is received by first dispatching a request for a channel guide web page. A representation of a web page comprising a channel guide is then presented to a user. Although not limited in scope to wireless applications, the present invention comprises a method wherein the request for a channel guide web page is conveyed to a computer network, for example the Internet, by conveying a network protocol packet containing the request to a wireless access point. Likewise, when a data packet is received from the Internet, it is wirelessly conveyed from the wireless access point to the hand-held device. According to one variation of the present method, the request for a web page and subsequent receipt of a web page representation is accomplished using a network protocol. In one example variation of this invention, transmission control protocol/Internet protocol (TCP/IP) is used to accomplish both the request for and subsequent receipt of a web page.

One alternative variation of the present method provides that presentation of the channel selection tool is effected by presenting a tool activation control on a presentation screen. A channel selection window is then presented on the presentation screen when a user actuates the tool activation control. Generally, the channel selection window is prepared by instantiating an unobscurable presentation window and populating the window with channel selection controls. Then, the instantiation of the channel selection window is enabled for display on the presentation screen. One feature of the present invention that facilitates concurrent presentation of a channel guide and the channel selection tool is that taught by one alternative method of the present invention. According to this alternative method, the unobscurable presentation window can be repositioned on the display screen according to repositioning commands received from a user. This alternative method further provides that a portion of the presentation screen formerly obscured by the presentation window is repainted. This, in effect, restores the presentation of the channel guide originally received as a web page.

According to one alternative method of the present invention, a channel selection is received by sensing a sequence of position indications within the channel selection tool. These position indications are then converted to a sequence of numerals and interpreted as a channel indicator. According to one variation of this present method, the sequence of position indications is interpreted as either a channel up or a channel down command. In yet another variation of this method, the sequence of position indications are recognized as a handwritten character that is subsequently converted to a channel indicator. The position indications are recognized by means of a touch sensitive screen or other cursor positioning/selection device, for example a “mouse”. Once a channel selection is received from a user, one example method of the present invention provides for conveying the channel selection to a content receiver by converting the channel selection into a bitstream and wirelessly conveying the bitstream to content receiver.

The invention further comprises an apparatus for remotely controlling a content receiver. According to one illustrative embodiment of the present invention, the remote control apparatus comprises a receiver for receiving a channel guide, a presentation device, a channel selection tool and a transmitter for conveying a channel selection to a content receiver. According to this example embodiment of the present invention, the presentation device is used for presenting the channel guide and the channel selection tool. Accordingly, the transmitter receives the channel selection from the channel selection tool when the tool is used by a user.

According to one alternative embodiment of the present invention, the receiver comprises a web page presentation module and a network interface. The web page presentation module generates a request for a channel guide web page. This request is conveyed to the network interface, which propagates the request to a server attached to a computer network, for example, the Internet. When a web page script is received in response to the request, the web page presentation module renders an image according to a web page script, e.g. a hyper-text markup document. According to one alternative embodiment of the present invention, the network interface comprises a wireless network interface.

According to yet another alternative embodiment of the present invention, the presentation device comprises a graphical presentation screen and a tool manager. The tool manager displays a tool activation control on the screen. When a user actuates the tool activation control, the tool manager displays a channel selection tool on the screen. According to one example of embodiment of the present invention, the presentation device further comprises a screen manager. The tool manager displays the channel selection tool on the screen by creating a window definition for an unobscurable presentation window and populating this window definition with channel selection controls. This window definition is then conveyed to the screen manager, which then displays the window on the presentation screen. According to yet another alternative embodiment of the present invention, the screen manager is capable of receiving movement commands from a user. These movement commands, which pertain to the unobscurable presentation window, are used as a basis for repositioning the presentation window on the presentation screen. The screen manager then repaints a portion of the presentation screen that was obscured by the presentation window prior to the move.

According to one alternative embodiment of the present invention, the presentation device further comprises a cursor positioning/selection device (for example a “mouse”) or a touch screen sensor. The screen manager receives position indications from the cursor positioning/selection device or from the touch screen sensor. The presentation device further comprises a selection interpreter that receives position indications from the screen manager and converts these indications into one of either a channel up command or channel down command. In an alternative embodiment of the invention, the selection interpreter converts position indications into a numeric channel indicator. In yet another alternative embodiment of the present invention, the selection interpreter correlates position indications received from the screen manager with a handwritten character, which is then converted to a channel indicator.

According to one alternative embodiment of the present invention, the transmitter comprises a serializer and a transducer. Once a channel selection is received, the serializer converts the channel selection into a serial bitstream that is then conveyed to the transducer. The transducer converts the bitstream into electromagnetic radiation that can be conveyed to the content receiver in order to effect remote control thereof.

### BRIEF DESCRIPTION OF THE DRAWINGS

The foregoing aspects are better understood from the following detailed description of one embodiment of the invention with reference to the drawings, in which:

FIG. 1 is a flow diagram that describes one illustrative method of transmitting a channel selection to a content receiver according to the present invention;

FIG. 2 is a flow diagram that illustrates one example method of receiving a channel guide according to the present invention;

FIG. 3 is a flow diagram that depicts one example method of dispatching a channel guide web page request and receiving a web page representation by wireless means according to the present invention;

FIG. 4 is a flow diagram that depicts one variation of the method of the present invention whereby a channel selection tool is presented;

FIG. 5 is a flow diagram that describes one example method of presenting a channel selection window according to the method of the present invention;

FIG. 6 is a flow diagram describing one variation of the present method that provides for receiving repositioning commands from a user;

FIG. 7 is a flow diagram that depicts one illustrative method of receiving a channel selection according to the method of the invention;

FIG. 8 is a flow diagram that describes one variation of the method of the present invention whereby a channel selection is conveyed to a content receiver;

FIG. 9 is a block diagram of one example embodiment of an apparatus capable of remotely controlling a content receiver according to the present invention;

FIG. 10 is a data flow diagram that further describes the interaction of functional modules constituting an apparatus for controlling a content receiver according to the present invention;

FIG. 11 is a pictorial diagram that illustrates one example placement of a tool activation control icon on a presentation device according to the present invention; and

FIG. 12 is a pictorial diagram showing one example illustration of a channel selection tool image displayed on a presentation device.

The components in the figures are not necessarily to scale, emphasis instead being placed upon illustrating the principles of the invention. In the figures, like reference numerals designate corresponding parts throughout the different views

### DETAILED DESCRIPTION OF THE INVENTION

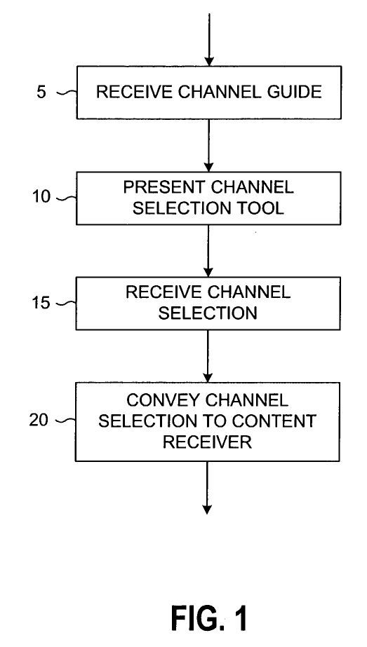

FIG. 1 is a flow diagram that describes one illustrative method of transmitting a channel selection to a content receiver according to the present invention. According to this illustrative method, a channel guide is received (step 5) and presented to a user. In one variation of the inventive method, the guide is a TV channel guide that resides in a server on the Internet and that can be viewed using a web browser. In yet another variation of this illustrative method, a specific channel guide is retrieved when a user enters a ZIP code and selects a particular television reception scheme, for example a particular cable television or satellite subscription service. In still another variation of this method, a web browser is presented on a hand-held device comprising a screen and a wireless connection to the Internet.

Once a channel has been located, the user may wish to select that channel and to convey the selection to a content receiver so as to receive the programming associated with the channel selection. According to the present invention, a channel selection tool is presented (step 10) for this purpose. In one variation of the present method, the user selects a desired channel and the selection is received (step 15). The channel selection then is conveyed to the content receiver (step 20).

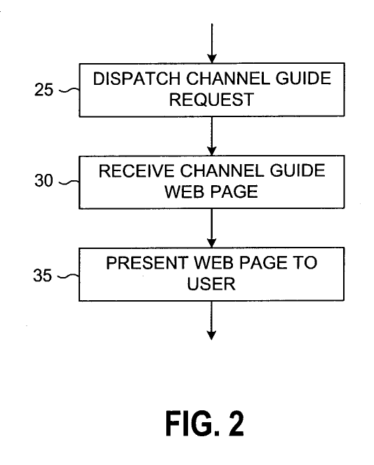

FIG. 2 is a flow diagram that illustrates one example method of receiving a channel guide according to the present invention. According to this example method, a request is dispatched to the Internet for a channel guide web page (step 25). In one variation of this method, a browser is used to dispatch the request. In response to the request, a web page representation of the channel guide is received (step 30), and the web page representation is presented to the user (step 35). In yet another variation of the present method, the web page is received from the Internet by a web browser function incorporated into a hand-held Internet appliance.

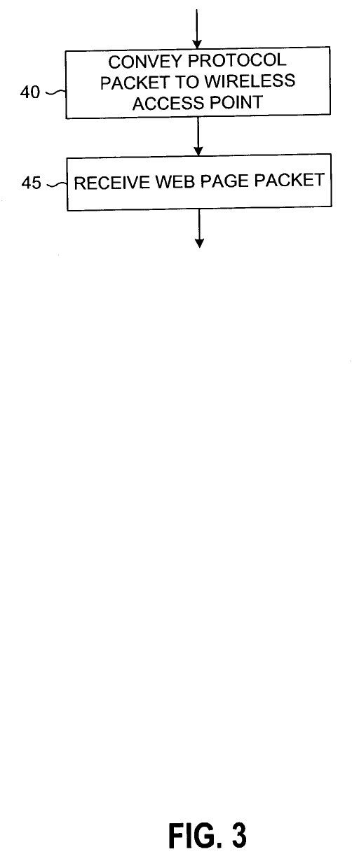

FIG. 3 is a flow diagram that depicts one example method of dispatching a channel guide web page request and receiving a web page representation by wireless means according to the present invention. In this example method, a network protocol packet, the payload of which comprises the request, is created and conveyed to a wireless access point (step 40) that interfaces with the Internet. One or more web page packets, embodied as network protocol packets, are received (step 45) in response to the request packet. The received packet is received by the wireless access point from the Internet and propagated to a wireless, hand-held Internet appliance. The received web page packet, when decoded, comprises the requested web page representation. Generally, the data packets are formed as transmission control protocol/Internet protocol (TCP/IP) packets.

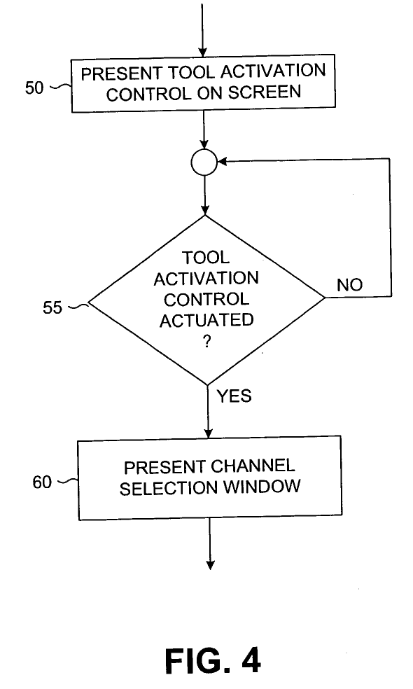

FIG. 4 is a flow diagram that depicts one variation of the method of the present invention whereby a channel selection tool is presented. According to this variation of the present method, a tool activation control is presented on a screen (step 50). In one illustrative example of this method, the tool activation control comprises an icon. When the tool activation control is actuated (step 55), a channel selection window is presented (step 60).

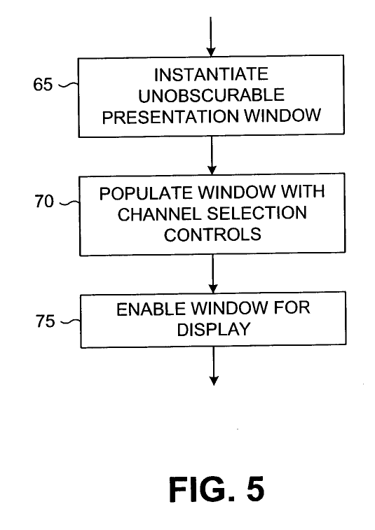

FIG. 5 is a flow diagram that describes one example method of presenting a channel selection window according to the method of the present invention. According to this example, an unobscurable presentation window is instantiated (step 65). The window then is populated with channel selection controls (step 70), and the window is enabled for display (step 75). The unobscurable characteristic of the presentation window assures that the window appears to the user as an overlay over other information that previously occupied the display.

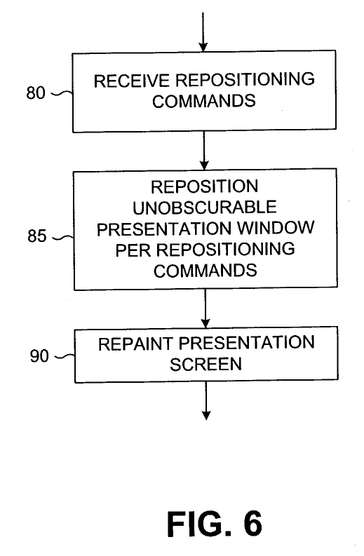

FIG. 6 is a flow diagram describing one variation of the present method that provides for receiving repositioning commands from a user. In this variation repositioning commands are received (step 80). In response to these repositioning commands, one variation of the method of the present invention provides that the unobscurable window is moved around on the presentation screen (step 85). When so moved, the information previously presented on the screen and obscured by the channel selection window is restored when the channel selection window is moved to a new location on the screen (step 90). In one variation of the present method, the selection controls comprise numerals 0-9, channel-up and channel-down indicators, and an enter button.

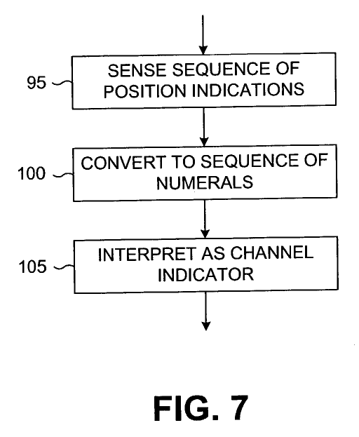

FIG. 7 is a flow diagram that depicts one illustrative method of receiving a channel selection according to the method of the present invention. This illustrative method calls for sensing a sequence of position indications (step 95) within a presentation window constituting a channel selection tool, converting the sequence of position indications to a sequence of numerals (step 100), and interpreting the resulting sequence of numerals as a channel indicator (step 105). In one variation of the method, the sequence of position indications is a sequence of “taps” imparted by a user on a touch-sensitive screen. In another variation of the method, the sequence of position indications is a sequence of “clicks” received from a cursor positioning/selection device (for example, a mouse) where the sequence of clicks is correlated with a sequence of cursor positions. In still another variation of the method, the sequence of position indications is decoded as a sequence of handwritten characters that are recognized as numerals that subsequently are converted into a channel selection. In yet another variation of the method, the sequence of position indications is decoded as a sequence of channel-up/channel-down commands that are interpreted as channel indications.

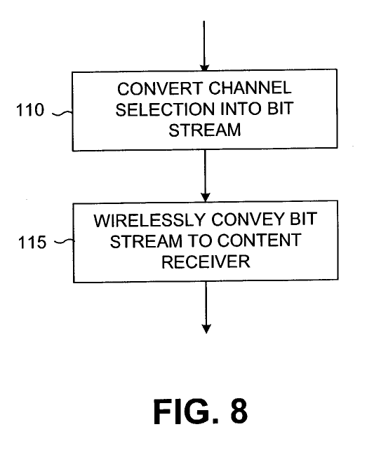

FIG. 8 is a flow diagram that describes one variation of the method of the present invention whereby a channel selection is conveyed to a content receiver. According to this example method, the channel selection is converted into a bit stream (step 10), and the bit stream is wirelessly conveyed to a content receiver (step 115). In yet another example variation of the present method, the bit stream is conveyed to a content receiver using infrared light that is modulated according to the bit stream. In another example method of the present invention, a radio-frequency signal is modulated according to the bit stream and conveyed to the content receiver.

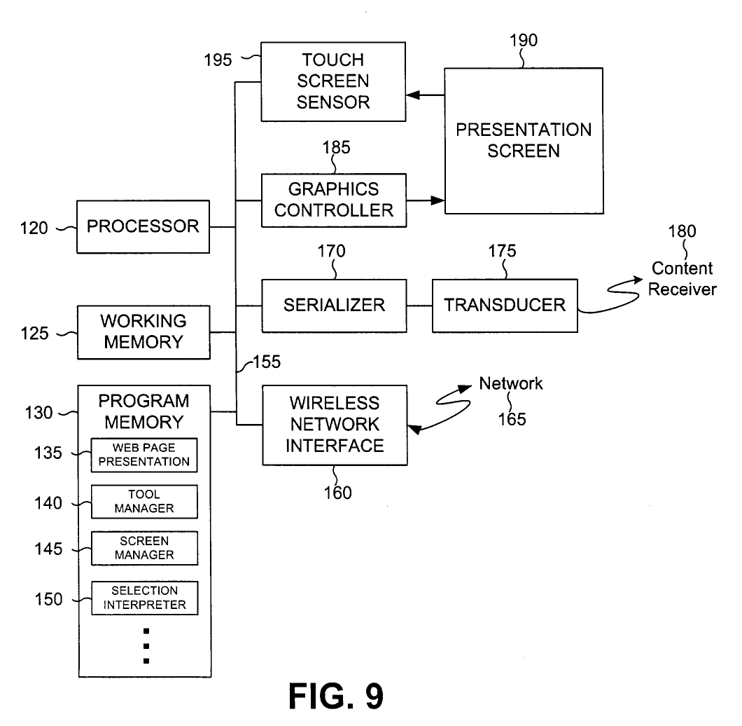

FIG. 9 is a block diagram of one example embodiment of an apparatus capable of remotely controlling a content receiver according to the present invention. The apparatus comprises a special-purpose computer comprising a processor 120, working memory 125, and program memory 130, all interconnected by a system bus 155. Instruction sequences stored in the program memory 130 comprise a web page presentation instruction sequence 135, a tool manager instruction sequence 140, a screen manager instruction sequence 145, and a selection interpreter instruction sequence 150. One alternative embodiment of the present invention further comprises a wireless network interface 160 that connects to the system bus 155. The wireless network interface 160 enables communication between the apparatus and a computer network 165. The apparatus still further comprises a wireless transmitter comprising a serializer 170 in cascade with a transducer 175, said serializer 170 acting to translate a channel selection into a bit stream and to present the bit stream to the transducer 175. In one embodiment of the invention the transducer 175 comprises an infrared power intensity modulator and an infrared transmitter that accepts the output of the modulator and transmits the result as an infrared signal to a content receiver 180. In yet another embodiment of the present invention, the transducer 175 comprises an RF modulator and an antenna. Accordingly, the RF modulator modulates a radio frequency signal according to the bit stream generated by the serializer 170 and conveys the signal to the antenna, from when it is emanates as a wireless conveyance to the content receiver.

One example embodiment of the present invention even further comprises a graphics controller 185 and a presentation screen 190. In yet another alternative embodiment of the present invention, the apparatus comprises a touch screen sensor 195. The graphics controller 185, which connects to the system bus 155 and to the screen 190, converts signals on the system bus 155 to graphical images that can be presented on the screen 190. The touch screen sensor 195, which likewise connects to the system bus 155 and to the screen 190, converts taps imparted by a user on the presentation screen 190 into signals on the system bus 155.

Each of the instruction sequences stored in program memory 130, when loaded and executed by the processor 120, causes the processor 120 to implement a functional module according to the instruction sequence. Generally, the description of a functional module constitutes a specification for a corresponding instruction sequence. Although many different instruction sequences could implement a given module, these instruction sequences are considered to be equivalent from the point of view of the present invention. Some aspects of the operation of this apparatus are best described in terms of these functional modules.

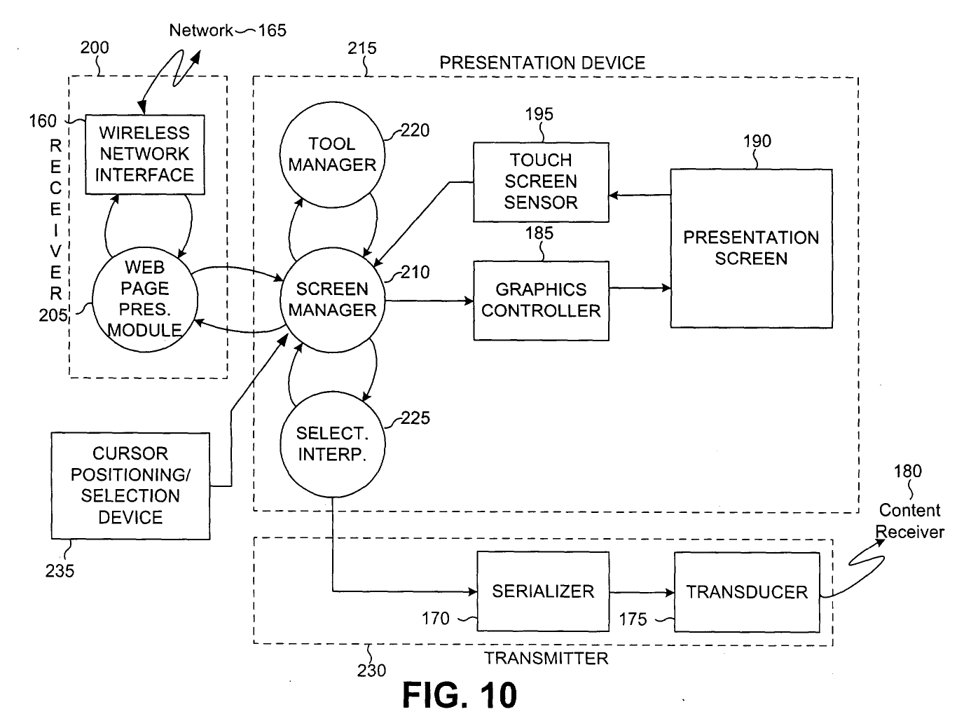

FIG. 10 is a data flow diagram that describes the interaction of functional modules constituting an apparatus for controlling a content receiver according to the present invention. According to this view, one example embodiment of the invention comprises a receiver 200 that comprises a wireless network interface 160 and a web page presentation module 205. According to one alternative embodiment of a receiver 200, the web page presentation module 205 receives an indication from the screen manager 210 that a channel guide web page is required. Accordingly, the web page presentation module 205 generates a request for a channel guide web page and directs the request to the wireless network interface 160. The wireless network interface 160 conveys the request to a server attached to a computer network 165, for example the Internet. In response to the request, the wireless network interface 160 receives a web page script, and the script is passed to the web page presentation module 205. The web page presentation module, that according to one alternative embodiment comprises a web browser, renders an image according to the received script and conveys the image to the screen manager 210.

This example embodiment further comprises a presentation device 215 that comprises a tool manager 220, a screen manager 210, a graphical presentation screen 190, a graphics controller 185, and a selection interpreter 225. In yet another alternative embodiment of the present invention, the presentation device further comprises a touch screen sensor 195. The tool manager 220 creates a representation of a tool activation control image. The image is conveyed to the screen manager 210 and thence to the graphics controller 185 that presents the tool activation control image on the presentation screen 190 as an icon. When the user selects the icon as a request to activate a channel selection tool, the screen manager 210 generates a channel selection tool request and passes it to the tool manager 220. The tool manager 220 initiates display of a channel selection tool image by instantiating a window definition for an unobscurable presentation window (i.e., a window that always overlays any other information on the display), and populates the window with channel selection controls. According to one alternative embodiment of the invention, the channel selection controls comprise numerals 0-9, channel-up and channel-down controls, and an enter button.

The tool manager 220 then conveys a representation of the resulting image of the channel selection tool to the screen manager 210. The screen manager 210 passes the channel selection tool image to the graphics controller 170 that presents the image on the presentation screen 190. The user selects a desired channel by actuating the channel selection controls constituting the channel selection tool. According to one alternative embodiment of the invention, the screen manager 210 receives tap indications from the touch screen sensor 195 and interprets the sequence of taps as a sequence of position indications. The screen manager 210 passes the sequence of position indications to the selection interpreter 225 that converts the indications into a channel indicator. In one alternative embodiment of the present invention the sequence of position indications is interpreted by the selection interpreter 225 to represent handwritten characters. The selection interpreter 225 recognizes the characters, converts them to numerals, and interprets the result as a channel indication.

In another alternative embodiment of the apparatus, position indications are received by the screen manager 210 from a cursor positioning/selection device 235 that replaces the touch screen sensor 195. One example of a cursor positioning/selection device comprises a mouse.

The channel selection tool image initially may overlay information that the user wishes to see on the display. When this happens, the user may reposition the channel selection tool to expose the desired information. In one embodiment of the present invention the user touches an area on the screen 190 that is occupied by the channel selection tool image. The user then drags the touched area to a new location on the screen, thereby producing repositioning commands that are received by the touch screen sensor 195. The touch screen sensor 195 conveys the repositioning command to the screen manager 210 that creates an image definition according to the new position for the channel selection tool image. The screen manager 210 also creates an image definition for the screen area exposed by the repositioning of the channel selection tool image. The screen manager 210 then conveys the new image definitions to the graphics controller 185 that presents the revised image on the screen 190.

According to one alternative embodiment of the present invention, a cursor positioning/selection device 235 (mouse) is used to initiate the repositioning commands.

This particular embodiment still further comprises a transmitter 230 comprising a serializer 170 and a transducer 175. The serializer 170 receives a channel indicator from the selection interpreter 225, converts the channel indicator into a serial bit stream and passes the bit stream to the transducer 175. The transducer 175 converts the bit stream to a wireless signal that it transmits to a content receiver 180.

According to one alternative embodiment of the invention, the transducer comprises a light emitting diode that emits infrared light according to the bit stream. In yet another alterative embodiment of the present invention, the transducer comprises a radio frequency modulator and an antenna. Accordingly, the modulator generates a radio frequency signal that is modulated according to the bit stream and directs this signal to the antenna. The signal then emanates from the antenna so that it may be received by the content receiver.

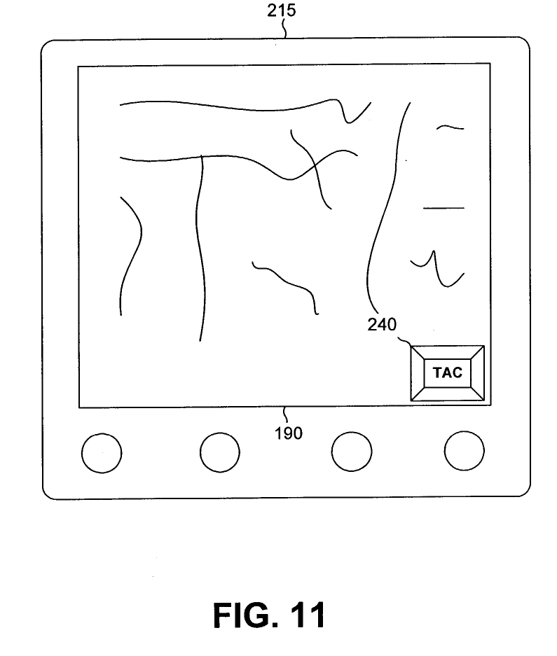

FIG. 11 is a pictorial diagram that illustrates one example placement of a tool activation control icon on a presentation device according to the present invention. According to this example embodiment of the present invention, a tool activation control icon 240 is presented in a corner of the presentation screen 190 constituting a presentation device 215, for example a wireless Internet appliance.

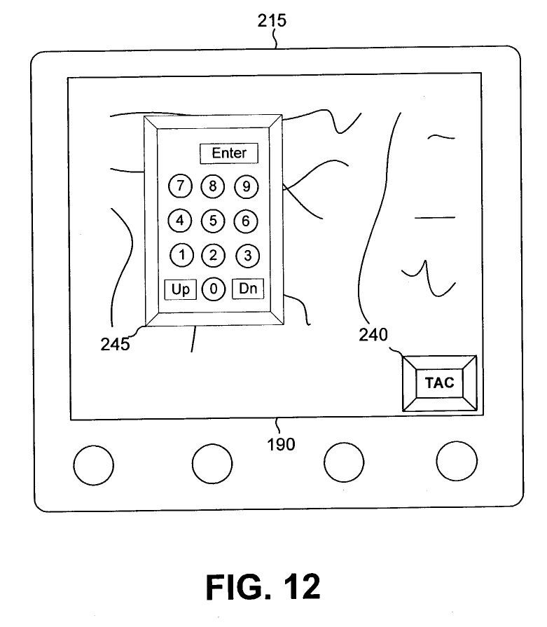

FIG. 12 is a pictorial diagram showing one example embodiment of a channel selection tool image displayed on a presentation device. The presentation device 215 typically comprises a display screen 190 that displays the channel selection tool image 245. This image 245 comprises numerals 0-9 and other buttons labeled Up (for channel-up), Dn (for channel-down), and Enter in this illustrative example.

The tool activation control image 240, the channel selection tool image 245 and the associated button labels in FIGS. 11 and 12 are for illustration only and should not be interpreted to limit the intended scope of the present invention.

### ALTERNATIVE EMBODIMENTS

While this invention has been described in terms of several preferred embodiments, it is contemplated that alternatives, modifications, permutations, and equivalents thereof will become apparent to those skilled in the art upon a reading of the specification and study of the drawings. It is therefore intended that the true spirit and scope of the present invention include all such alternatives, modifications, permutations, and equivalents.

What is claimed is:

1. A method for remotely controlling a content receiver comprising:
receiving a channel guide;
presenting a channel selection tool to a user;
receiving a channel selection from the channel selection tool; and
conveying the channel selection to the content receiver.

2. The method of claim 1 wherein receiving a channel guide comprises:
dispatching a request for a channel guide web page;
receiving a web page representation for the channel guide; and
presenting the web page representation to a user.

3. The method of claim 2 wherein dispatching a request for and receiving a web page representation comprises:
wirelessly conveying a network protocol packet to a wireless access point; and
wirelessly receiving a network protocol packet constituting a web page from the wireless access point.

4. The method of claim 1 wherein presenting a channel selection tool comprises:
presenting a tool activation control on a presentation screen; and
presenting a channel selection window when the tool activation control is actuated.

5. The method of claim 4 wherein presenting a channel selection window comprises:
instantiating an unobscurable presentation window;
populating the presentation window with channel selection controls; and
enabling the presentation window for display to a user.

6. The method of claim 5 further comprising:
receiving repositioning command from a user;
repositioning the unobscurable presentation window according to the repositioning command;
repainting a portion of the presentation screen that was obscured by the presentation window.

7. The method of claim 1 wherein receiving a channel selection comprises:
sensing a sequence of position indications within the channel selection tool;
converting the sequence of position indications to a sequence of numerals; and
interpreting the sequence of numerals as a channel indicator.

8. The method of claim 7 wherein sensing a sequence of position indications comprises one or more of sensing a mouse click and sensing a touch-screen tap.

9. The method of claim 1 wherein receiving a channel selection comprises:
sensing a sequence of position indications within the channel selection tool; and
converting the sequence of position indications to either of a channel up or channel down command.

10. The method of claim 1 wherein receiving a channel selection comprises:
sensing a sequence of position indications within the channel selection tool;
recognizing the sequence of position indications as a handwritten character;
converting the handwritten character into a channel indicator.

11. The method of claim 1 wherein conveying the channel selection to the content receiver comprises:
converting the channel selection into a bit stream; and
wirelessly conveying the bit stream to the content receiver.

12. An apparatus for remotely controlling a content receiver comprising:
receiver for receiving a channel guide;
presentation device for presenting a channel selection tool to a user;
channel selection tool for receiving a channel selection from the user; and
transmitter for conveying the channel selection to the content receiver.

13. The apparatus of claim 12 wherein the receiver comprises:
web page presentation module that generates a request for a channel guide web page; and
network interface that conveys the request to a server and wherein the web page presentation module further renders an image according to a received web page script.

14. The apparatus of claim 13 wherein the wherein the network interface comprises a wireless network interface.

15. The apparatus of claim 12 wherein the presentation device comprises:
graphical presentation screen; and
tool manager that displays a tool activation control on the screen and displays a channel selection tool on the screen when the activation control is actuated.

16. The apparatus of claim 15 further comprising a screen manager that controls the graphical presentation screen and wherein the tool manager displays a channel selection tool by:
creating a window definition for an unobscurable presentation window;
populating the window definition with channel selection controls; and
conveying the window definition to the screen manager for presentation on the presentation screen.

17. The apparatus of claim 16 wherein the screen manager further:
receives movement commands from a user;
moves the window according to the movement commands; and
repaints the portion of the presentation screen previously obscured by the presentation window.

18. The apparatus of claim 12 further comprising a screen manager that is capable of displaying a presentation window on the presentation device and receiving position indications within the presentation window and wherein the channel selection tool comprises:
presentation window that is displayed on the presentation device;
selection interpreter that receives position indications from the screen manager, converts said indications into a sequence of numerals and interprets the sequence of numerals as a channel indicator.

19. The apparatus of claim 18 further comprising a cursor position and selection device and wherein the screen manager receives position indications from the cursor position and selection device.

20. The apparatus of claim 18 further comprising a touch screen sensor and wherein the screen manager receives position indications from the touch screen sensor.

21. The apparatus of claim 12 further comprising a screen manager that is capable of displaying a presentation window on the presentation device and receiving position indications within the presentation window and wherein the channel selection tool comprises:
presentation window that is displayed on the presentation device;
selection interpreter that receives position indications from the screen manager and converts said indications into one of either a channel up command and a channel down command.

22. The apparatus of claim 12 further comprising a screen manager that is capable of displaying a presentation window on the presentation device and receiving position indications within the presentation window and wherein the channel selection tool comprises:
presentation window that is displayed on the presentation device;
selection interpreter that correlates position indications received from the screen manager with a handwritten character and converts said hand written character into a channel indicator.

23. The apparatus of claim 12 wherein the transmitter comprises:
serializer that converts the channel selection into a serial bit stream; and
transducer that converts the serial bit stream into electromagnetic radiation.
